(19) United States
(12) Patent Application Publication
(10) Pub. No.: US 2010/0060194 A1
(43) Pub. Date: Mar. 11, 2010

(54) EXTERNAL MICROCONTROLLER FOR LED LIGHTING FIXTURE, LED LIGHTING FIXTURE WITH INTERNAL CONTROLLER, AND LED LIGHTING SYSTEM

(75) Inventors: Kevin Furry, Briarcliff Manor, NY (US); Charles Sommerville, Briarcliff Manor, NY (US); Eric Peak, Briarcliff Manor, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/447,014

(22) PCT Filed: Nov. 13, 2007
(86) PCT No.: PCT/IB2007/054620

§ 371 Date: Apr. 24, 2009

Related U.S. Application Data
(60) Provisional application No. 60/865,687, filed on Nov. 14, 2006.

(51) Int. Cl. H05B 37/02

(52) U.S. Cl. 315/294; 315/291

(57) ABSTRACT

An LED lighting system (10) includes an LED lighting fixture (12) having at least one LED (14) and an external microcontroller (22, 28) for converting incoming lighting control data formatted according to the DMX512 standard to pulse-width modulated lighting control signals for input to the LED (14). The external microcontroller (22, 28) is preferably located inside a cable connector (20) adapted for releasably connecting a power cable (18) to the LED lighting fixture (12).

### BACKGROUND OF THE INVENTION

This invention relates to an LED lighting system, and more particularly relates to such a system having means for controlling the light output of the system in accordance with lighting control signals.

The use of lighting control signals to control LED lighting systems is known. For example, U.S. Pat. No. 6,016,038 describes a multicolored LED lighting method and apparatus capable of generating light for illumination or display purposes, in which the LEDs are controlled by a processor providing pulse-width modulated signals to alter the brightness and/or color of the generated light, enabling the generation of complex, predesigned patterns of light.

Stage lighting and room lighting are traditionally controlled by a dimmer. In the case of AC-powered units, the output waveform of the 60 hz AC signal is chopped using the method of pulse-width modulation (PWM).

The controllers used for this purpose may be external, i.e., units which connect to a network and to power but are external to the lamp assembly. They output control signals and or PWM signals to lamps. Alternatively, the controllers may be internal, i.e., units which connect to networks and to power, and function the same as external controllers, but are inside the lamp assembly and share the lamp power supply and are thus dedicated to the lamp assembly.

In the case of DC-powered units, such as signs and displays composed of addressable matrices of up to thousands of individual LEDs, serial data in the form of serial packets containing image or message data for LED control is processed by a software-driven CPU. The data is converted into a form suitable for addressing the LED matrix, e.g., color data, and stored into memory. The data is then used to produce pulse-width modulated signals for control of the light output of the LEDs.

In the case of simpler DC-powered units, such as single or multiple LED lamps, the software-driven CPU can be replaced by an internal or external controller, which first converts the incoming serial control data into lighting control signals such as PWM signals., and then applies the lighting control signals to control the current to the LEDs.

One drawback of the use of such internal or external controllers is that the function of the fixture is determined by the function of the controller, and thus cannot be changed. In addition, internally-mounted controllers are subject to damage during installation of the light fixtures, requiring costly repairs.

According to the invention, a removable cable with connector, contains an electronic circuit (herein referred to as a microcontroller) for conversion of a lighting protocol input such as DMX512, DALI, ZIGBEE or other communication protocol, into a pulse-width modulated (PWM) LED control signal. The PWM signal is fed to one or more LED lighting units to control LED current and enable and disable LEDs in order to produce varying levels of brightness.

By locating the protocol conversion circuit in the cable, the design of the LED fixture is simplified. Moreover, the function of the fixture can be changed by simply changing the cable. In addition, removal of the conversion electronics from inside the fixture avoids the possibility of damage to the electronics during installation of the fixture, which would otherwise result in costly repairs.

In accordance with one aspect of the invention, there is provided an LED lighting system comprising an LED lighting fixture comprising at least one LED and an external microcontroller for converting incoming lighting control data to lighting control signals.

In accordance with a preferred embodiment of this aspect of the invention, the LED lighting fixture also comprises an internal controller for further controlling the LED, e.g., in response to voltage and/or temperature data.

In accordance with another preferred embodiment of this aspect of the invention, the LED lighting system further comprises a cable for supplying the lighting control data to the external microcontroller; and a cable connector for releasably connecting the cable to the LED lighting fixture.

While the external microcontroller is preferably located inside the cable connector, it may alternately be located inside the cable itself, or inside a separate unit adapted for releasable connection to either the cable or the connector. In addition to supplying lighting control data to the external microcontroller, the cable preferably also supplies power to the LED lighting fixture.

The lighting control data will normally be provided in the form of serial data containing information for dimming of the light output of the LED fixture, such serial data preferably formatted in accordance with the DMX512 standard. The external microcontroller converts this lighting control data into a form which is compatible with the control function of the internal controller, such as pulse-width modulated lighting control signals.

Typically, a white LED light source will have a combination of one or more red, green and blue LEDs, which together produce a white light output.

In accordance with another aspect of the invention, there is provided an LED lighting fixture comprising at least one LED and an external controller for controlling the current to the LED in response to pulse-width modulated lighting control signals.

In accordance with yet another aspect of the invention, there is provided an external microcontroller for converting lighting control data to lighting control signals.

Preferably, the external microcontroller is located inside a cable connector integrally connected to a cable and adapted for releasably connecting the cable to an LED lighting fixture, but the external microcontroller may also be located inside the cable or inside a separate unit adapted for releasable connection to the cable or the cable connector.

### BRIEF DESCRIPTION OF THE DRAWINGS

These and other aspects of the invention will be further elucidated with reference to the drawing figures, in which:

FIGS. 1A and 1B are schematic diagrams of the component parts of one embodiment of an LED lighting control system in accordance with the invention;

FIG. 2 is a schematic diagram of one embodiment of the external microcontroller component of the system of FIGS. 1A and 1B;

FIG. 3 is a schematic diagram of another embodiment of the external microcontroller component of the system of FIGS. 1A and 1B;

FIG. 4 is a block diagram of one embodiment of the external microcontroller; and

FIG. 5 is a block diagram of one embodiment of the internal controller of the LED light fixture.

The figures are diagrammatic and not drawn to scale. The same reference numbers in different Figures refer to like parts.

### DETAILED DESCRIPTION OF THE PREFERRED EMBODIMENTS

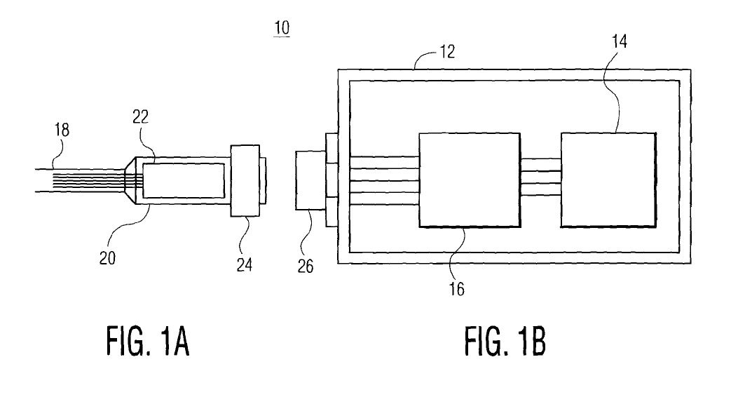

FIGS. 1A and 1B show schematically component parts of one embodiment of an LED lighting control system 10 of the invention, which includes an LED lighting fixture 12 having at least one LED 14 and an internal controller 16 for controlling the current to the LED 14 in response to lighting control signals; and an external microcontroller 22 for converting incoming DMX-formatted lighting control data to pulse-width modulated lighting control signals for input to the internal controller 16. The external microcontroller 22 is located inside a cable connector 20, which connector 20 is adapted for releasably connecting a power cable 18 to the LED lighting fixture 12 via the plug 24 and socket 26.

LED 14 in this embodiment includes three separate LEDs, a red LED, a green LED and a blue LED, whose emissions combine to form white light.

The internal controller or LED driver has up to three control functions: (a) control of LED current; (b) control of LED temperature; and (c) LED ON or OFF. In addition, the internal controller may have these additional features: (d) power supply DC to DC; (e) power supply AC to DC; and (f) signal protection circuitry.

The external microcontroller is the PWM generator. The external microcontroller may have these options: (a) DMX/serial conversion to PWM; (b) DALI/1-10V dimmer conversion to PWM; (c) PWM generator; (d) no PWM output.

DMX (Digital Multiplex) 512 is a protocol developed by the USITT that describes a method of digital data transmission between controllers and lighting equipment and accessories. It covers electrical characteristics (based on the EIA/TIA-485 standard), data format, data protocol, and connector type. See the USITT website at www.usitt.org.

DALI (Digital Addressable Lighting Interface) is a protocol set out in the technical standard IEC 929. See the IEC website at www.iec.ch.

One way of achieving the desired functions of the internal controller and the external microcontroller is to modify the design of an existing DMX512 dimmer by removing the high current output driver and placing it in the LED fixture. The conversion circuitry remaining in the dimmer is then miniaturized to fit insider the cable and connector. The cable can now be attached to any LED fixture having a compatible design.

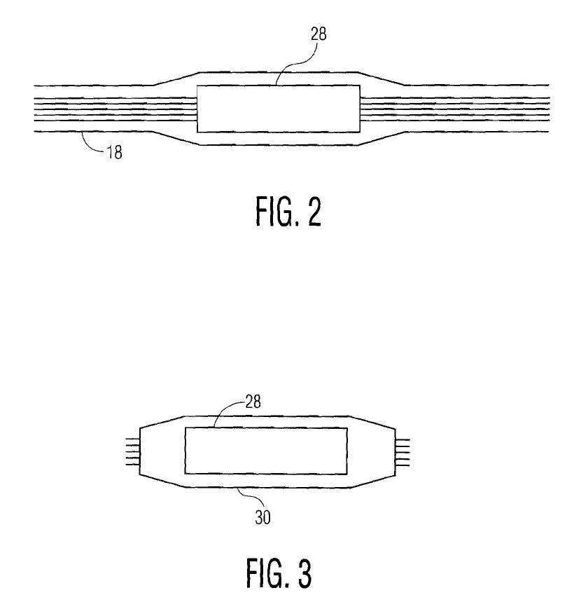

As shown in FIGS. 2 and 3, the microcontroller 28 may alternately be located in the cable 18, or may be incorporated into a separate unit 30 which plugs into the cable or into the cable connector between the cable and the lighting fixture.

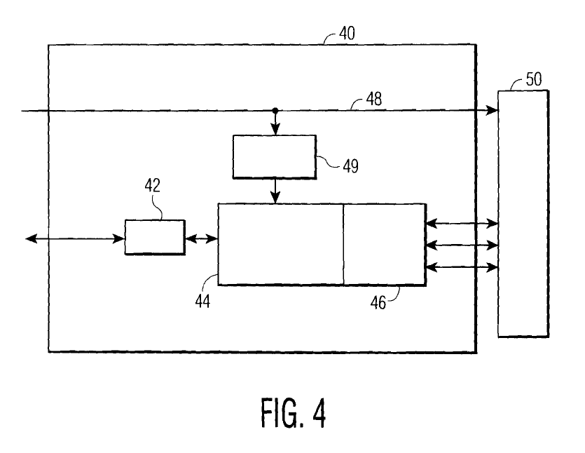

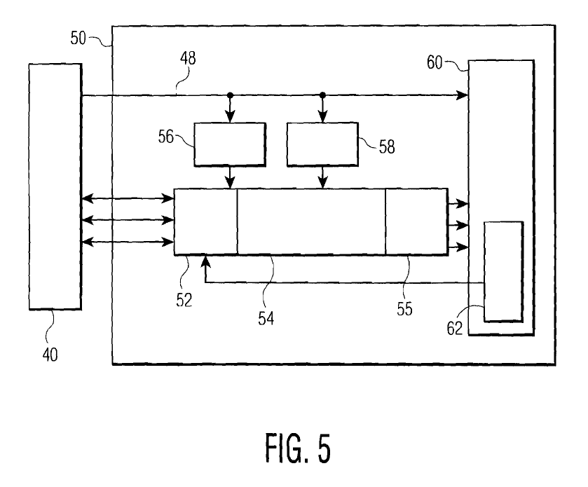

FIG. 4 is a block diagram showing the relationship of functional components of one embodiment of the external microcontroller (22, 28), which in this embodiment is located inside cable 40. Incoming lighting control data in the form of RS485, DMX512, DALI or other serial data, is received by UART 42, converted into digital data using standard serial protocol (N start bits, 8 data bits, 1 stop bit, no parity) although other known protocols may be used. CPU 44 includes a Processor, RAM and Flash Memory. The digital data, now in the form of bytes, is transmitted by UART 42 to CPU 44, where it is stored in RAM.

A program of control instructions including mainly lighting control instructions, but in this embodiment also temperature control instructions, resides in Flash Memory, and governs the processing of the digital data transmitted by UART 42.

For example, where the incoming serial data represents intensity of RED, GREEN and BLUE LEDs, the CPU will wiggle corresponding output port signals from HIGH to LOW at different percentages based on the RGB data bytes provided by UART 42. The percentages represent 256 different intensity levels, with 0% HIGH representing 0 and 100% HIGH representing 255. These PWM output port signals are then provided through Input/Output Ports 46 to Lamp 50.

Power is supplied to CPU 44 from Power line 48 via Power Regulator 49, which protects and converts the power in the cable to operate the electronics in the microcontroller (22, 28).

FIG. 5 is a block diagram showing the relationship of functional components of one embodiment of the internal microcontroller 16, which in this embodiment is located inside Lamp 50. Incoming lighting control signals in the form of PWM lighting control signals from Cable 40, are input through Input/Output Ports 52, which detect HIGH or LOW PWM signals from the Output Ports 46 of Cable 40. These PWM signals are passed to LED Unit 60 through ENABLE Output Ports 55 essentially without modification. The LED Unit 60 has a pc board with constant current switches which switch ON in response to HIGH signals and OFF in response to LOW signals.

CPU 54, including a Processor, RAM and Flash Memory, provides additional PWM HIGH and LOW signals between 0% and 100% in response to input from the Voltage Sensor 56 and Temperature Sensor 62, which are also output through ENABLE Output Ports 55 to LED Unit 60 to control voltage and temperature.

Power is supplied to CPU 54 from Power line 48 via Power Regulator 58.

The invention may be used in a lighting system comprising one or more LED lighting fixtures, alone or in combination with one or more other light sources, e.g., fluorescent light sources, connected in parallel or in series, and may occur in lighting networks, in combination with other components whose connections may be wired or wireless. Examples of such lighting networks are described in U.S. Pat. Nos. 6,046,978 and 6,636,005, the specifications of which are incorporated herein by reference.

The invention has necessarily been described in terms of a limited number of embodiments. From this description, other embodiments and variations of embodiments will become apparent to those skilled in the art, and are intended to be fully encompassed within the scope of the invention and the appended claims. For example, the voltage and temperature regulation function may be transferred to the cable or eliminated entirely, in which case the lamp controller may be replaced by wires connecting the input/output ports to the enable output port of the lamp.

1. An LED lighting system comprising:
an LED lighting fixture comprising at least one LED;
an external microcontroller for converting lighting control data to lighting control signals for input to the lighting fixture;
a cable for supplying lighting control data to the microcontroller; and
a cable connector for releasably connecting the cable to the LED lighting fixture wherein the external microcontroller is located inside the cable.

2. The LED lighting system of claim 1, further comprising an internal controller for further controlling the LED.

3. The LED lighting system of claim 1, wherein the connector is integrally connected to the cable.

4. The LED lighting system of claim 1, wherein the cable supplies power to the LED lighting fixture.

5. (canceled)

6. The LED lighting system of claim 1, wherein the LED lighting fixture comprises at least one red LED, at least one green LED and at least one blue LED.

7. The LED lighting system of claim 1, wherein the lighting control data supplied to the external microcontroller by the cable is serial data.

8. The LED lighting system of claim 7, wherein the lighting control data is formatted in accordance with the DMX512 standard.

9. The LED lighting system of claim 7, wherein the external microcontroller converts the lighting control data to pulse-width modulated lighting control signals.

10-18. (canceled)
